(19) United States
(12) Patent Application Publication
(10) Pub. No.: US 2011/0315727 A1
(43) Pub. Date: Dec. 29, 2011

(54) DVD player attachment for baby stroller

(76) Inventors: Jennie G. Ferraioli, Sayville, NY (US); Brian Ferraiol, Sayville, NY (US)

(21) Appl. No.: 12/803,257

(22) Filed: Jun. 23, 2010

(51) Int. Cl. B60R 7/00

(52) U.S. Cl. 224/409

(57) ABSTRACT

DVD player attachment for baby stroller with a DVD player housing, an articulated elongate arm member and a clamping member. The arm member is attached at one end to the rear of the DVD housing by of a friction ball joint and attached at the opposite end to the clamping member. The DVD player housing includes a hinged top cover. The top cover has a child proof latch that can removably engage a recess in the side wall of the lower portion of the housing. The top cover has an aperture for viewing the video screen of the DVD player and has additional apertures for allowing audio sound to travel freely out from the DVD player. The player housing side has an aperture for allowing signals emanating from a remote control device to enter the housing and control the DVD player located within the housing.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of baby stroller accessories and more specifically to a DVD player attachment for baby stroller.

Baby Strollers are a well known way of transporting young children from one location to another. Care givers are always looking for new ways to entertain young children, even while the child is sitting in a stroller.

To this end, various attachments have been designed to be added to a stroller for keeping the child entertained while seated in the stroller. My U.S. Pat. No. 7,657,954 describes a stroller with integral media entertainment and education center for a baby, in which the stroller includes a built in DVD player and video screen that allows the child to view videos while sitting in the stroller.

However, my U.S. Pat. No. 7,657,954 only describes a DVD player that is built into a stroller. There is still a need for the ability to attach a DVD player to any existing stroller so that a person who already owns a stroller does not have to purchase an entirely new stroller, but need only purchase a DVD player attachment.

### BRIEF SUMMARY OF THE INVENTION

The primary object of the invention is to provide a DVD player housing and attachment arm for a baby stroller that allows a user to easily attach a DVD player to a stroller so that a baby sitting in the stroller can view a DVD or other video presentation.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed DVD player attachment for baby stroller comprising: a DVD player housing, an articulated elongate arm member, a damping member, said arm member attached at one end to the rear of said DVD housing by means of a friction ball joint, said arm member attached at the opposite end to said clamping member, said DVD player housing including a hinged top cover, said top cover having a child proof latch that can removably engage said a recess in the side walls of the lower portion of said housing, said top cover having an aperture for viewing the video screen of said DVD player, said top cover having additional apertures for allowing audio sound to travel freely out from said DVD player, and said player housing side having a aperture for allowing signals emanating from a remote control device to enter said housing and control said DVD player.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention in use on a baby stroller.

FIG. 2 is a perspective view of the invention showing the clamp portion attached to a baby stroller.

FIG. 3 is a perspective view of the DVD player housing of the invention with the top cover in the open position.

FIG. 4 is a front perspective view of the DVD housing and arm of the present invention.

FIG. 5 is a rear perspective view of the DVD housing and arm of the present invention.

FIG. 6 is a top view of the DVD housing and attachment arm of the present invention.

FIG. 7 is a side section view of the DVD housing and attachment arm of the present invention.

FIG. 8 is a perspective view of an alternate embodiment of the attachment arm of the present invention.

FIG. 9 is a perspective view of an alternate embodiment where the video screen and DVD player portion are separated.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

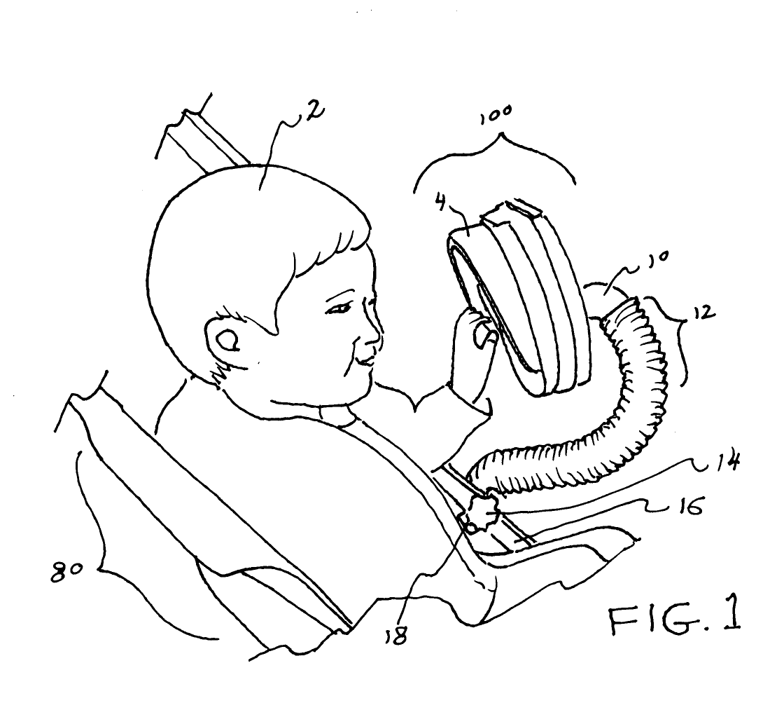

Referring now to FIG. 1 we see a perspective view of a small child 2 seated in a standard stroller 80. An adjustable elongate arm 12 is attached to the stroller frame 16 by a clamp 18 and clamp knob 14. The arm 12 is covered with a flexible outer sheath and terminates at its upper end in an J shaped member 10 which in turn is attached to the back of DVD housing 100. Sun shade hood 4 shades the screen of the DVD player from direct sunlight. A standard remote control device, not shown, can operate the DVD player stored in the housing 100.

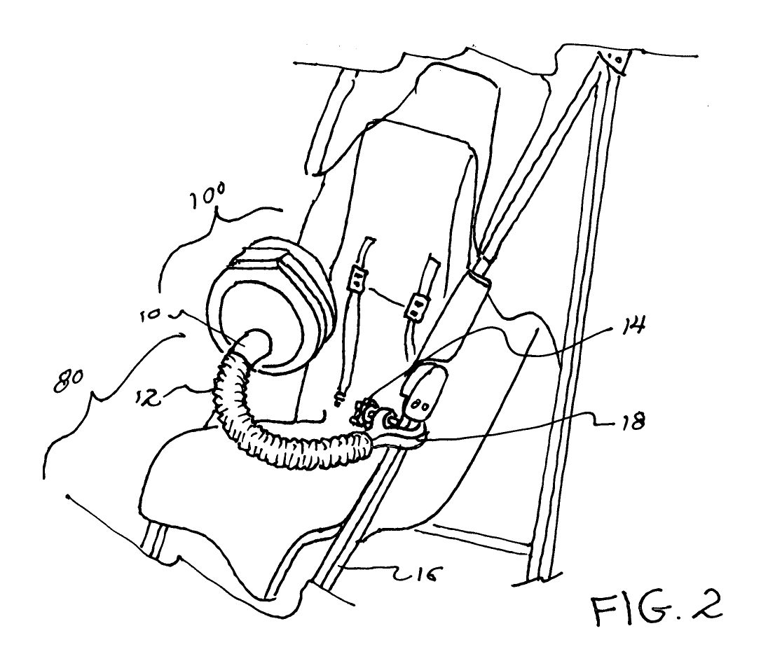

FIG. 2 shows another perspective view of the invention attached to the stroller 80. This view more clearly shows the clamp member 18 as it is attached to stroller frame member 16 and tightened in place by knob 14. Arm member 12 is attached at its lower most point to clamp 18 and at its upper end to DVD housing 100. The clamp 18 can be placed at any convenient location along the frame 16 of the stroller. The clamp 18 can also be attached to the railing of a child's crib, or to other frame-like members such as a headrest support post of the front passenger seat of a vehicle thereby enabling a child sitting in a rear seat to view a video.

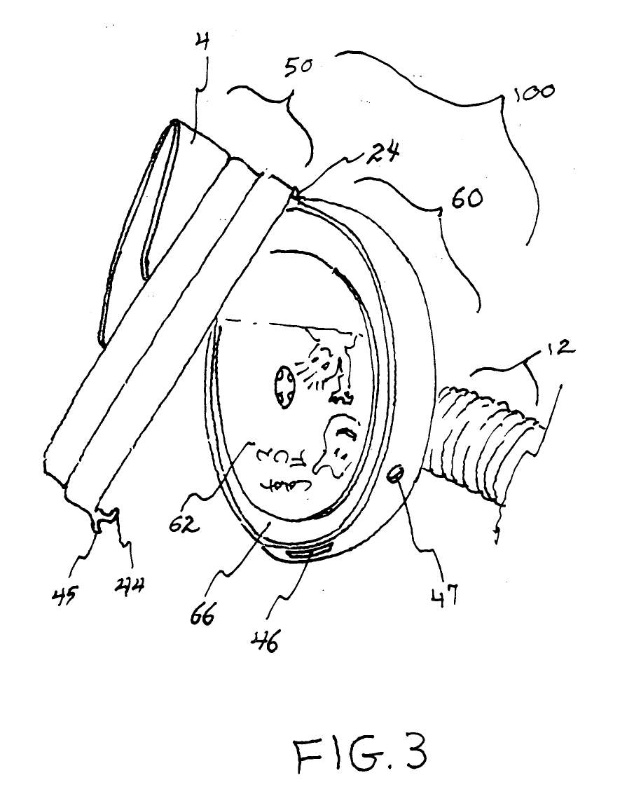

FIG. 3 shows a perspective view of the DVD housing 100 in the open position. The housing is composed of a bottom portion 60 and a top portion 50. A DVD 62 is installed in the player 66. The top portion 50 and the bottom portion 60 are attached by hinge member 24. The top portion 50 houses a video screen, associated electronics and at least one audio speaker. The DVD player 66 is similar to one manufactured by E Motion Inc. and includes a three and one half inch video screen. Alternately, the DVD player 66 can be removed from the housing 60 and replaced with a FLO TV personal television that receives a signal in the same way that a cell phone does. This allows any TV show to be viewed in real time. Aperture 64 allows the signal sent from a standard remote controller to enter the DVD player 66 and control the player 66. The FLO TV also includes a three and one half inch screen, so the aperture in the housing 66 is sized properly for either the DVD player or the FLO TV device. Other Video devices may also be placed in housing 100 as technology advances and produces new video devices. Aperture 47 allows the signal from the remote transmitter to enter the housing and be received by a transmitter located within DVD player 66.

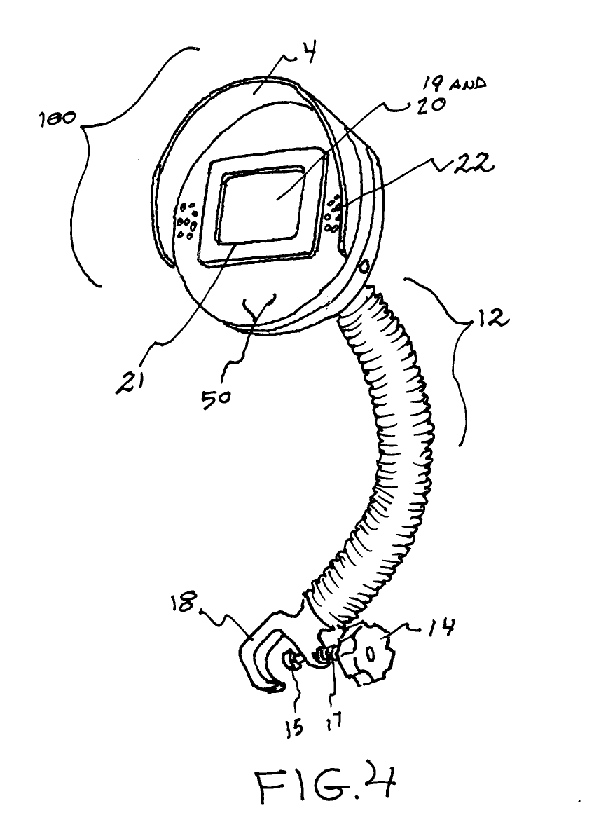

FIG. 4 shows a front perspective view of the invention. A transparent plastic sheet covers Video screen 20 can be clearly viewed through housing aperture 21. The transparent plastic sheet prevents small children from directly touching the screen 20. Additionally, all the controls for the DVD player 66 located within housing 100 are covered by top cover 50 so that small children can not touch them. A plurality of apertures 22 allows audio sound to exit the housing top 50.

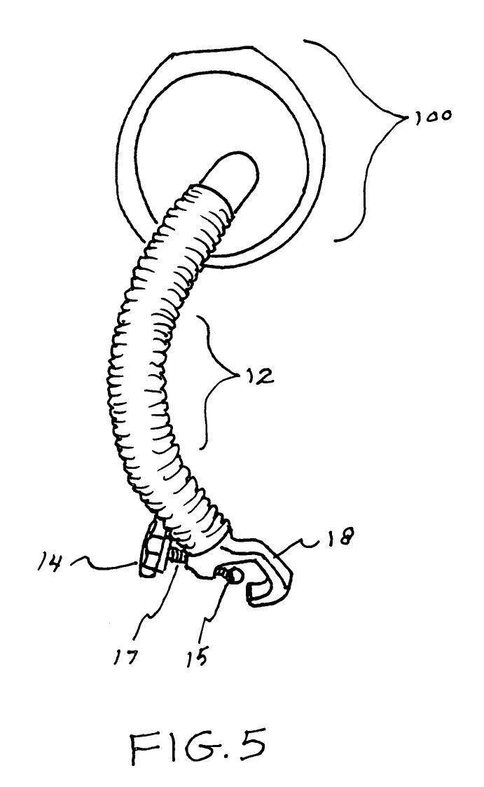

FIG. 5 shows a rear perspective view of the invention. A clear view of clamp 18 and tightening knob 14 can be seen. An elongate threaded member 17 passes through a mating female thread in clamp 18 and terminates in a rubber tip so that the end of the threaded member 17 does not scratch the stroller frame that it is clamped to.

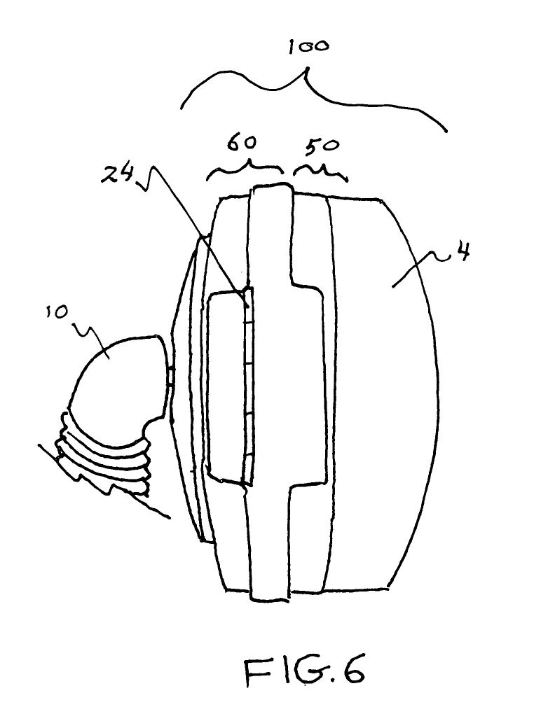

FIG. 6 shows a top view of the housing 100. Hinge member 24 can be clearly seen as well as the relationship of bottom housing half 60, top housing half 50 and sun shade 4.

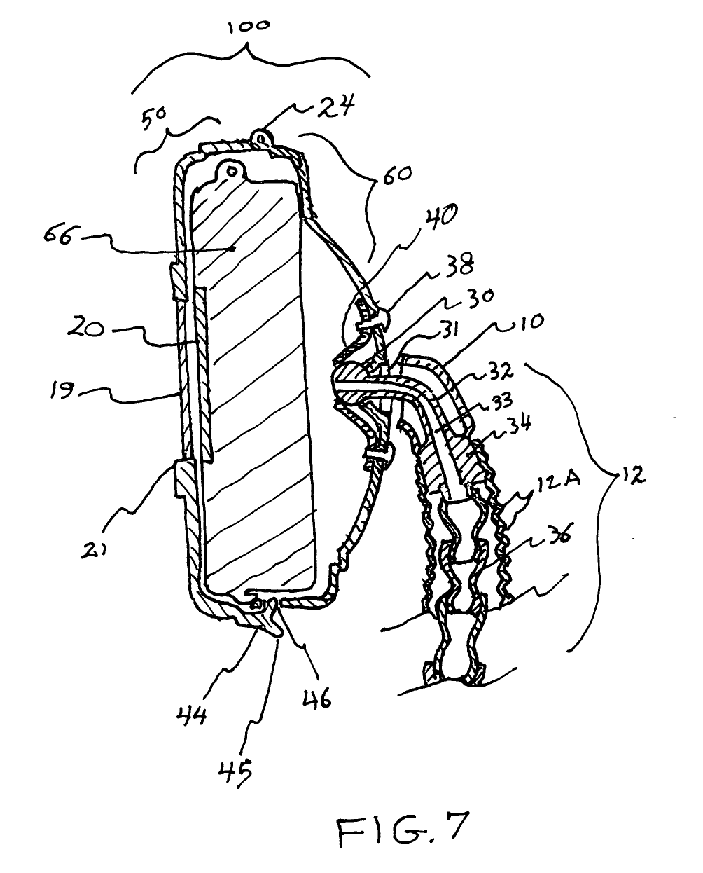

FIG. 7 shows a side section view that bisects the housing 100 and part of elongate arm 12. A standard compact DVD player 66 fits inside housing halves 60, 50. The video screen 20 can be viewed through rigid, transparent sheet 19 that covers housing aperture 21. The rear portion of housing bottom 60 includes an aperture 31 that allows a bent arm 32 to penetrate and be fastened by retaining plate 38. Plate 38 is fixed onto the inside wall of housing 60 bottom by screws 38 being attached to threaded apertures in retaining plate 38. The plate 40 frictionally retains a ball shaped tip 30 that is fixed onto the end of bent arm 32. This allows the user to swivel the housing 100 or to rock the housing 100 to a desired angle for ideal viewing. A child resistant latch 44 located on the side of the top housing 50 engages a recessed portion 46 in the bottom housing portion 60 also shown in FIG. 3. Lifting tab 45 allows the stroller operator to open the latch 44. The lifting strength needed to separate the latch 44 is greater than the strength of a small child's fingers. Other standard latches may be substituted for the latch shown in FIG. 7. Hinge member 24 can be clearly seen. The elongate arm 12 is comprised of several items. A flexible tubular outer sheath 12A encloses the structural elements of the arm assembly 12. A J shaped end cover 10 encloses bent arm 32. Bent arm 32 terminates at one end in ball shaped tip 30 and on the opposite end in sheath retaining insert member 34. The sheath retainer 34 includes a lower neck that fixedly retains the top most section of an adjustable elongate structure 36 comprised of a series of hollow members that have a partial spherical shape on each end and where the sphere shape of one end is snapped onto the sphere portion of the end below it. This type of construction can be found on snap-loc coolant hoses used for aiming a cooling mist at a part being cut while being machined. Each connection of the members of the elongate inner structure 36 provides enough frictional force to hold the arm 12 in place in the position that it is moved to by the user. The opposite end of the inner adjustable structure 36 is fixed to the clamp member 18.

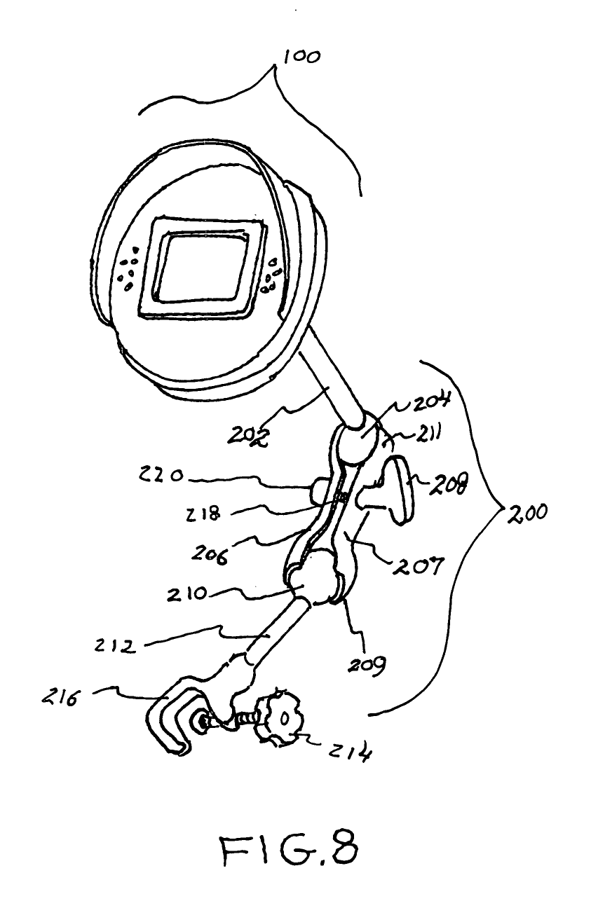

An alternate embodiment of the arm structure can be found in FIG. 8. Arm structure 200 is comprised of two straight shaft members 202, 212 rotatably attached to central clamping member comprised of clamping halves 206, 207 and damping knob 208. A threaded shaft 218 is attached to the underside of knob 208 and engages mating female threads located in protrusion 220. Shaft member 212 terminates on one side in clamp member 216 including tightening knob 214, and on the other side in ball member 210. Shaft 202 terminates on one side in ball member 204 and on the opposite side in a smaller ball shaped member similar to the one 30 described in FIG. 7 so that it can engage the back wall of the DVD housing 100 as described in FIG. 7. The central clamping assembly terminates on each end in ball retaining cups 209, 211. The user can loosen the damping knob 208, adjust the arms 202, 212 so that the DVD housing 100 is in the optimal position for viewing, and then tighten the knob 208 so that the arm assembly 200 is fixed in place. This type of arm assembly allows heavier DVD players and housings 100 to be held firmly in place. The first arm assembly 12 only holds by the frictional force of the structural arm pieces 36. However, the first arm assembly 12 is easier and more economical to manufacture as well as looking more sleek in comparison to arm assembly 200.

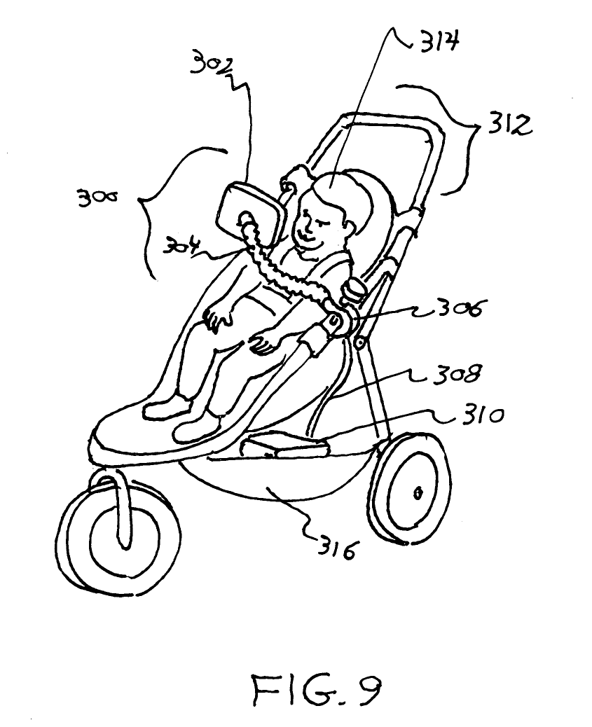

FIG. 9 shows a perspective view of an alternate embodiment 300 of the invention. In this embodiment the video screen and audio speaker portion 302 of the DVD player is separated from the rest of the DVD player 310. The screen and speaker portion 302 are connected by electric cable 308 to DVD player 310 which is stored in the carry section 316 found below the seat of most standard strollers 312. The clamping member 306 and adjustable arm 304 are that same as those found in the first embodiment. The hollow area 33 in the bent shaped arm portion 32 shown in FIG. 7 as well as the hollow nature of the adjustable connecting members 36 allows the electrical cable 308 to travel through the arm assembly 112 and be attached to the video screen 302. In this way, a larger video screen may be used for viewing while the heavier and larger portion of the DVD player 310 can be held safely in the stroller storage area.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. DVD player attachment for baby stroller comprising:
a DVD player housing;
an articulated elongate arm member;
a clamping member;
said DVD player housing comprised of an upper half and a lower half connected by a hinge member,
said arm member attached at one end to the rear of said DVD housing by means of a friction ball joint;
said arm member attached at the opposite end to said clamping member;
said DVD housing upper half having a child proof latch;
said latch removably engageable with a recess in the side wall of said lower half of said housing;
said upper half housing including a top cover having an aperture for viewing the video screen of said DVD player;
said top cover having additional apertures for allowing audio sound to travel freely out from said DVD player; and
said player housing lower half having an aperture for allowing signals emanating from a remote control device to enter said housing and control said DVD player.

2. DVD player attachment for baby stroller as claimed in claim 1 wherein said arm assembly is comprised of a plurality of frictionally attached members;
each said member terminating on one side in a larger hollow spherical portion and on the opposite side in a smaller hollow spherical portion;
said larger spherical portion of an upper said member capable of snapping onto said smaller spherical portion of a lower said member;
said members capable of being adjusted by said user allowing said DVD player housing to be positioned in front of the face of a child sitting in said stroller;
said frictionally attached members surrounded by a flexible tubular sheath.

3. An alternate embodiment of said DVD player attachment for baby stroller as claimed in claim 1 wherein said DVD player is separated from its video screen and speakers;
said DVD player stored in a compartment located under the seat of said stroller;
said video screen and speakers attached to said arm member as claimed in claim 1;
said video screen and speakers electronically attached to said DVD player by an electric cable;
said cable retained within the confines of said flexible arm sheath.

4. DVD player attachment for a baby stroller as claimed in claim 1 wherein said viewing aperture in said upper housing is covered by a rigid transparent plastic sheet member.
